(19) United States
(12) Patent Application Publication
(10) Pub. No.: US 2021/0405913 A1
(43) Pub. Date: Dec. 30, 2021

(54) HOST ACCESS TRACKING IN A MEMORY SUB-SYSTEM

(71) Applicant: Micron Technology, Inc., Boise, ID (US)

(72) Inventors: Paul Stonelake, Santa Clara, CA (US); Anirban Ray, Santa Clara, CA (US); David Boles, Austin, TX (US)

(21) Appl. No.: 17/304,450

(22) Filed: Jun. 21, 2021

Related U.S. Application Data
(60) Provisional application No. 63/044,627, filed on Jun. 26, 2020.

(51) Int. Cl. G06F 3/06

(52) U.S. Cl. CPC G06F 3/0653; G06F 3/0673; G06F 3/0659; G06F 3/0604

(57) ABSTRACT

A processing device in a memory system tracks a plurality of memory access operations directed to a plurality of segments of data on the memory device and maintains a plurality of access counters corresponding to the plurality of segments. The processing device sorts the plurality of segments based on values of the corresponding access counters and filters the plurality of segments to identify a subset of the plurality of segments for which the values of the corresponding access counters satisfy a threshold criterion. The processing device further generates a notification comprising an indication of the subset of the plurality of segments and provides the notification to a host system after the expiration of a periodic interval.

### RELATED APPLICATIONS

This application claims the benefit of U.S. Provisional Application No. 63/044,627, filed Jun. 26, 2020, the contents of which are hereby incorporated by reference herein.

### TECHNICAL FIELD

Embodiments of the disclosure relate generally to memory sub-systems, and more specifically, relate to host access tracking in a memory sub-system.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The present disclosure will be understood more fully from the detailed description given below and from the accompanying drawings of various embodiments of the disclosure.

FIG. 1 illustrates an example computing system that includes a memory sub-system in accordance with some embodiments of the present disclosure.

FIG. 2 is a flow diagram of an example method of host access tracking in a memory sub-system in accordance with some embodiments of the present disclosure.

FIG. 3 is a flow diagram of an example method of maintaining access counters for segments of a memory device in a memory sub-system in accordance with some embodiments of the present disclosure.

FIG. 4 is a flow diagram of an example method of providing a host system with hints pertaining to segments of a memory device in a memory sub-system in accordance with some embodiments of the present disclosure.

FIG. 5 is a block diagram illustrating a hint reporting timeline in accordance with some embodiments of the present disclosure.

FIG. 6 is a block diagram illustrating access count filtering in accordance with some embodiments of the present disclosure.

FIG. 7 is a block diagram of an example computer system in which embodiments of the present disclosure can operate.

### DETAILED DESCRIPTION

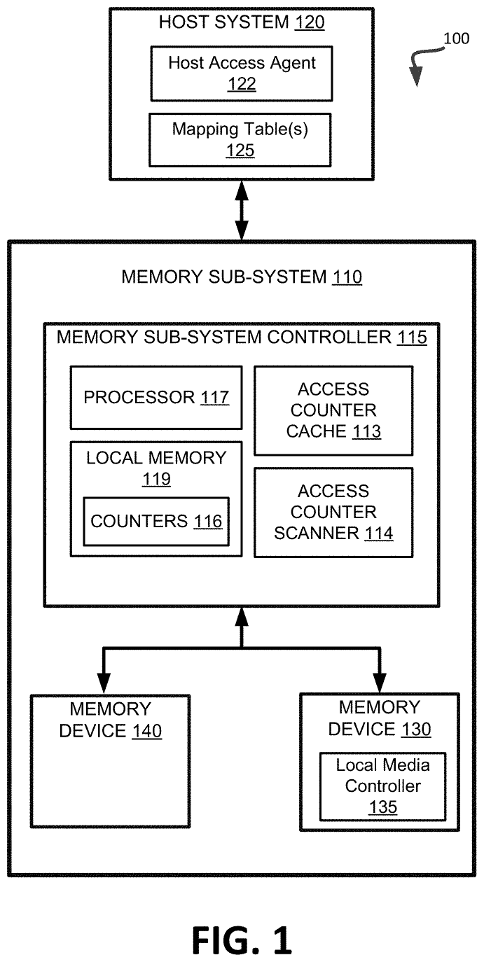

Aspects of the present disclosure are directed to host access tracking in a memory sub-system. A memory sub-system can be a storage device, a memory module, or a hybrid of a storage device and memory module. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system.

A memory sub-system can include high density non-volatile memory devices where retention of data is desired when no power is supplied to the memory device. One example of a non-volatile memory device is write-in-place memory, such as a three-dimensional cross-point (“3D cross-point”) memory device, which is a cross-point array of non-volatile memory cells. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. Other examples of non-volatile memory devices are described below in conjunction with FIG. 1. Some types of non-volatile memory devices are divided into memory units of a certain size, where each unit includes a set of pages. Each page consists of a set of memory cells (“cells”). A cell is an electronic circuit that stores information. Depending on the cell type, a cell can store one or more bits of binary information, and has various logic states that correlate to the number of bits being stored. The logic states can be represented by binary values, such as “0” and “1”, or combinations of such values.

Certain systems have multiple tiers of memory having different performance characteristics. For example, while the memory sub-system includes one tier of memory (e.g., 3D cross-point memory), the host system connected to the memory sub-system can further include some other tier of memory. Depending on the implementation, this host memory can be volatile memory (e.g., dynamic random access memory (DRAM)). The host memory, for example, can be faster than other tiers of memory, and due to its physical location in the host system, can offer lower access latency than other tiers of memory. The host memory, however, can be more expensive and have a lower capacity than other tiers of memory and thus, can be used as a cache to store the data most frequently accessed by an operating system or other applications executing on the host system. Accordingly, the host system must identify the most relevant units of data from the memory sub-system which are to be maintained in the host memory.

Conventional host systems periodically initiate a scan of certain segments of data (e.g., 4 kilobyte pages) stored on the memory devices of the memory sub-system (e.g., the 3D cross-point memory devices) to identify the most frequently accessed segments. Upon identifying those segments, the host system can initiate a migration of those pages from the memory sub-system to the host memory where they can be maintained and made available for faster access. For example, the host system can maintain a mapping table including entries corresponding to each segment of data which indicate whether the corresponding segments were accessed by the host system within some period of time. The nature of this process, however, includes a relatively long scanning period (e.g., several seconds or more). For example, the host system can poll registers of the memory sub-system over a communication interface (e.g., a compute express link (CXL) interface) in order to read access frequency statistics, which takes time and consumes memory traffic bandwidth. In one embodiment, host CPU virtual memory hardware provides support for access tracking on segments of data in a page table (i.e., a map of virtual to physical address spaces). The host operating system scans the page table and resets the access tracking bits to 0. The host CPU virtual memory hardware sets the access tracking bit back to 1 whenever an access has occurred, indicating which segments have been accessed since the last scan. As a result, the indication of recent access of a given segment is quickly very stale, and the host system might make sub-optimal decisions about which pages to migrate to the local host memory.

Aspects of the present disclosure address the above and other deficiencies by implementing host access tracking in the memory sub-system and providing a notification of such to the host system. In one embodiment, logic in the memory sub-system tracks host accesses to the segments of the memory devices of the memory sub-system, identifies the most frequently accessed segments in a given time period, determines whether the access frequency of those segments would be relevant to a decision making process of the host system, and if so, provides a notification of those segments to the host system. This notification serves as a hint to the host system, which the host system can use to make an informed decision about which segments of data to migrate to the host memory. The notification can be provided to the host system much more frequently than the host-polling technique (e.g., every 10 microseconds instead of 10 seconds), meaning that the segment usage information is more up-to-date. In one embodiment, the memory sub-system can send the notification to the host system using direct memory access (DMA) data transfer via the CXL interface into a circular buffer allocated by the host operating system. In one embodiment, the notification uses TLP processing hints (TPHs) and steering tags to target a CPU cache of the host system.

Advantages of the present disclosure include, but are not limited to an increase in the accuracy and timeliness of the data available to the host system in order to make decisions about what segments of data to migrate from the memory sub-system to the local host memory. As a result, the data in the host memory will be more reflective of recent data access patterns and less requests will be sent from the host system to the memory sub-system. The techniques described herein further provide the ability to detect operating conditions and workloads that will not meet performance expectations for the memory sub-system and enable the host operating system to perform some mitigation, including allocating more DRAM (e.g., for certain virtual machines) or migrating certain workloads to another socket or server. Furthermore, the techniques described herein provide the ability to profile application memory usage offline which can inform host operating system level page allocation strategies for specific applications.

FIG. 1 illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) and a hard disk drive (HDD). Examples of memory modules include a dual in-line memory module (DIMM), a small outline DIMM (SO-DIMM), and various types of non-volatile dual in-line memory module (NVDIMM).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to different types of memory sub-system 110. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a compute express link (CXL) interface, a serial advanced technology attachment (SATA) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access components (e.g., memory devices 130) when the memory sub-system 110 is coupled with the host system 120 by the physical host interface (e.g., PCIe bus). The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include negative-and (NAND) type flash memory and write-in-place memory, such as a three-dimensional cross-point (“3D cross-point”) memory device, which is a cross-point array of non-volatile memory cells. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 130 can include one or more arrays of memory cells such as SLCs, MLCs, TLCs, QLCs, or any combination of such. In some embodiments, a particular memory device can include an SLC portion, and an MLC portion, a TLC portion, a QLC portion, or a PLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, and electrically erasable programmable read-only memory (EEPROM).

A memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can be a processing device, which includes one or more processors (e.g., processor 117), configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory devices 130. The memory sub-system controller 115 can further include host interface circuitry to communicate with the host system 120 via the physical host interface. The host interface circuitry can convert the commands received from the host system into command instructions to access the memory devices 130 as well as convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, a memory device 130 is a managed memory device, which is a raw memory device combined with a local controller (e.g., local controller 135) for media management within the same memory device package. An example of a managed memory device is a managed NAND (MNAND) device.

In one embodiment, the memory sub-system 110 includes access counter cache 113 and access counter scanner 114. In some embodiments, the memory sub-system controller 115 includes at least a portion of access counter cache 113 and access counter scanner 114. For example, the memory sub-system controller 115 can include a processor 117 (e.g., a processing device) configured to execute instructions stored in local memory 119 for performing the operations described herein. In some embodiments, access counter cache 113 and access counter scanner 114 are part of the host system 110, an application, or an operating system. In other embodiment, local media controller 135 includes at least a portion of access counter cache 113 and access counter scanner 114 and is configured to perform the functionality described herein.

In certain embodiments, both access counter cache 113 and access counter scanner 114 can operate on a number of counters, such as counters 116, which can be maintained in local memory 119 (e.g., a dual-port static random access memory (SRAM)). Access counter cache 113 counts read and write accesses for segments of data of a certain size (e.g., 4 kilobytes) of memory device 130. If access counter cache 113 identifies a memory access operation directed to a particular segment (e.g., page), it can determine whether a counter corresponding to that segment is currently present in local memory 119. If not, access counter cache 113 can attempt to allocate a counter. If there is space permitting in local memory 119 (or a portion of local memory 119 designated for segment counters), a new counter can be allocated. Upon allocation of a counter, the page address is recorded as a tag in N-way set associative cache metadata. If a counter cannot be allocated, access counter cache 113 can record an overflow status for the corresponding row of the cache metadata. In one embodiment, each counter includes four saturating counters per segment. This can include a current value, and an accumulator value for read accesses and write accesses. The accumulator allows pages with a lower rate of accesses over multiple passes to be detected. In one embodiment, a content addressable memory (CAM) is used to handle overflow if any row of the cache metadata is all valid or to track single status bit overflow in any row. Whether an existing counter is identified or a new counter allocated, the current value of the counter is incremented for each memory access operation directed to the corresponding segment of data during the current time period. Access counter cache 113 can similarly update the accumulator value according to the type of memory access operations received.

Access counter scanner 114 periodically scans the segment counters in local memory 119. For example, access counter scanner 114 can make a pass over the counters every 10 microseconds. Upon reading the value of each counter, access counter scanner 114 can adjust values prior to a subsequent pass. In one embodiment, access counter scanner 114 adds the current value to the accumulator value and resets the current value to zero. The manner in which the current value and accumulator value are shifted is configurable depending on the specific implementation. If access counter scanner 114 determines that both the current value and the accumulator value are zero, access counter scanner 114 can deallocate the counter to make space available for a different segment of data. If access counter scanner 114 determines that at least one of the current value and the accumulator value are non-zero, access counter scanner 114 can add an indication of the corresponding segment to a candidate list. Access counter scanner 114 can further filter the candidate list to determine which segments should be reported to the host system 120. If one or more criteria are satisfied for a given segment, access counter scanner 114 can add a corresponding entry in an access record block including an identifier of the segment (e.g., page address) and the associated count value(s). Filtering the candidate list in this manner is intended to keep bandwidth for segment tracking hints to approximately 1% or less of the total available bandwidth during normal operation. The filtered candidate list can be provided to host system 120 where it is received by host access agent 122 (e.g., host CPU virtual memory hardware) and stored in mapping tables 125 (e.g., a page table or other map of virtual to physical address spaces). Further details with regards to the operations of access counter cache 113 and access counter scanner 114 are described below.

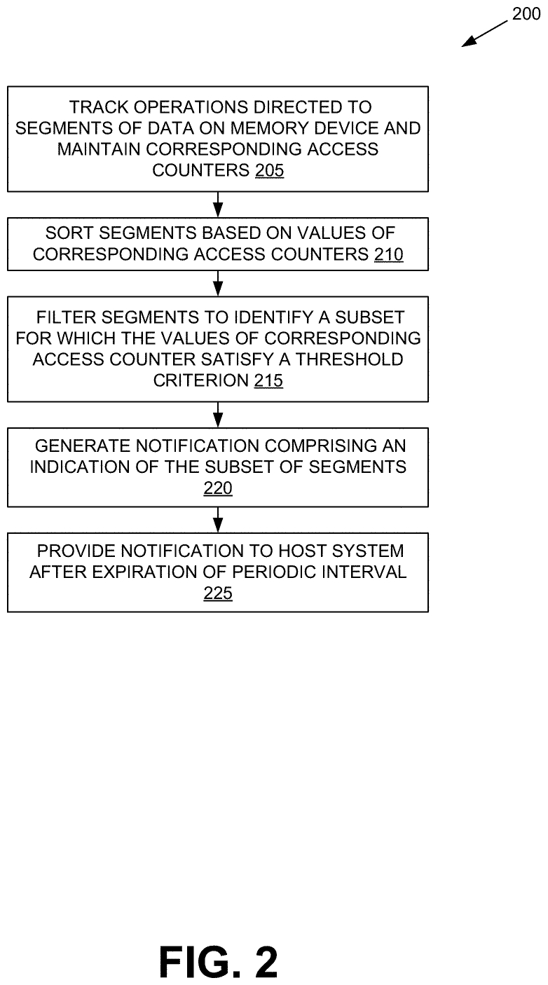

FIG. 2 is a flow diagram of an example method of host access tracking in a memory sub-system in accordance with some embodiments of the present disclosure. The method 200 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 200 is performed by memory sub-system controller 115, including access counter cache 113 and access counter scanner 114 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

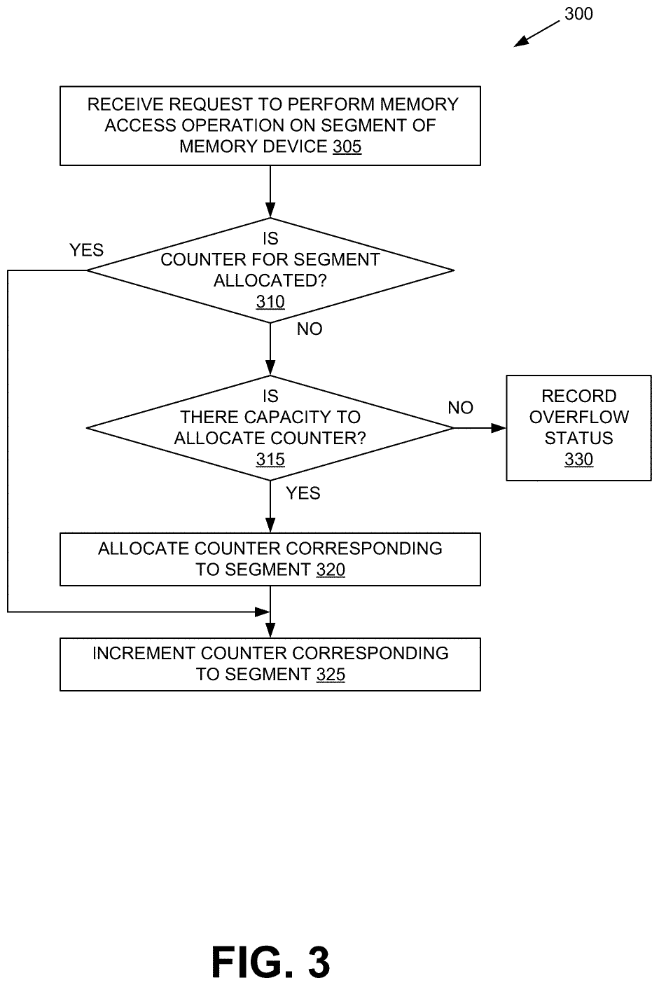

At operation 205, the processing logic tracks a plurality of memory access operations directed to a plurality of segments of data on the memory device and maintains a plurality of access counters corresponding to the plurality of segments. In one embodiment, memory sub-system controller 115 receives a plurality of requests to perform the memory access operations, such as program operations, or read operations, from a requestor, such as host system 120. Each request can be associate with a memory access operation to be performed on a certain segment of a memory device, such as memory device 130. In one embodiment, access counter cache 113 maintains a number of counters, such as counters 116, to reflect the number of requests received for (or the number of memory operations performed on) each segment (e.g., a 4 kilobyte page) of the memory device. Additional details are described below with respect to FIG. 3.

At operation 210, the processing logic sorts the plurality of segments based on values of the corresponding access counters. In one embodiment, access counter scanner 114 periodically scans the segment counters 116 in local memory 119. For example, access counter scanner 114 can make a pass over the counters 116 every 10 microseconds. Upon reading the value of each counter, access counter scanner 114 can reorder the segments, or at least a portion of the segments corresponding to the counters in view of the respective values. In one embodiment, access counter scanner 114 can sort the segments from a segment with a corresponding access counter having a highest value to a segment with a corresponding access counter having a lowest value.

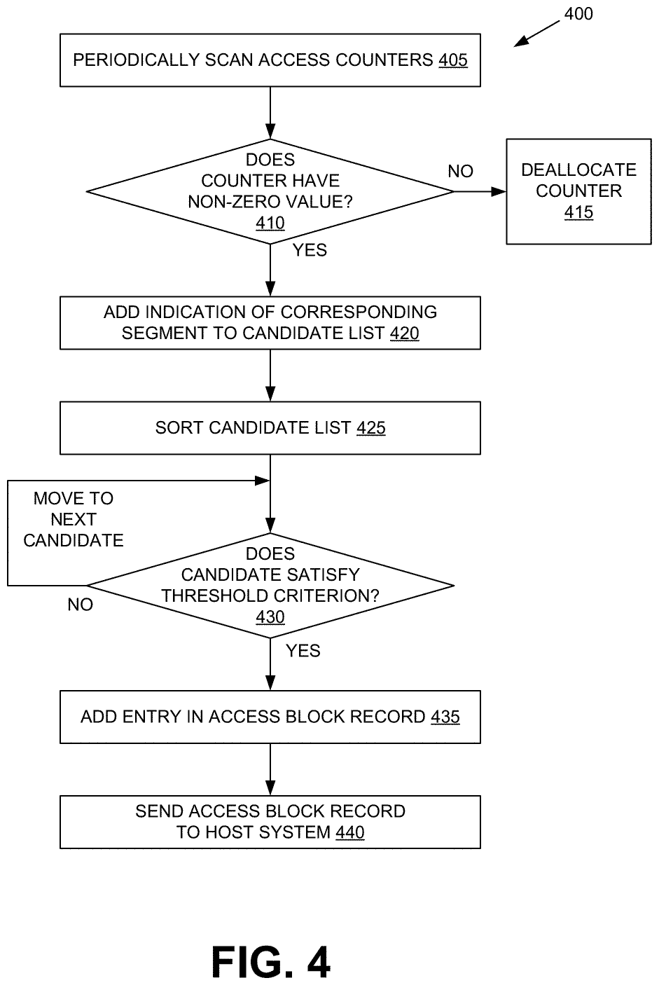

At operation 215, the processing logic filters the plurality of segments to identify a subset of the plurality of segments for which the values of the corresponding access counters satisfy a threshold criterion. In one embodiment, access counter scanner can identify those segments with corresponding access counters having values that exceed a threshold value. Additional details are described below with respect to FIG. 4.

At operation 220, the processing logic generates a notification comprising an indication of the subset of the plurality of segments. The notification serves as a hint for pages that meet the filter criteria. For example, access counter scanner 114 can generate the notification, also referred to as an access record block. In one embodiment, the access record block is 64 bytes in size (i.e., to match the host CPU cache line size) and leverages CXL.io TLP processing hints (TPHs) and steering tags to target a CPU cache of the host system 120. In one embodiment, the access record block includes a number of fields, such as: a signature field (indicating the start of the access record block), a size field (indicating the number of sectors in the access record block), a type field (indicating whether the access record block includes an access record or a summary record), an entity count field (indicating a number of valid access record entries), a sequence field (indicating a number of passes through the circular buffer), a status field (indicating whether overflow occurred), one or more entries (corresponding to the number of access records), a checksum field (including a checksum), and a signature field (indicating the end of the access record block). Depending on the embodiment, the access record block can include up to seven entries (i.e., the count values for up to seven segments of memory device 130).

At operation 225, the processing logic provides the notification to a host system after the expiration of a periodic interval. In one embodiment, access counter scanner 114 periodically sends one or more access record blocks to host system 120 using DMA, for example. Host system 120 can receive the access record blocks in a circular buffer, overwriting previous records. In one embodiment, host system 120 enables page tracking hints at a given time (e.g., the start of the day) and configures a start address and length of the circular buffer. Host system 120 can optionally notify memory sub-system 110 when an access record block is consumed, so that access counter scanner 114 can manage the sending of new access record blocks to avoid the overwrite of records that have not been consumed. Periodically, access counter scanner 114 can also send an access record summary to host system 120. In one embodiment, after a full pass through every row of the N-way associative cache, access counter scanner 114 can send an access record summary with up to seven entries indicating a resolution counter to allow the host system 120 to synchronize, a count of all segments (e.g., pages) accessed, a count of all segments for which the current value is greater than a threshold, a count of all segments for which the current value and the accumulator value are greater than a threshold, and a count of the number of rows that overflowed. In one embodiment, a configurable interrupt can be generated after the access record summary is sent to host system 120.

FIG. 3 is a flow diagram of an example method of maintaining access counters for segments of a memory device in a memory sub-system in accordance with some embodiments of the present disclosure. The method 300 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 300 is performed by memory sub-system controller 115, including access counter cache 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 305, the processing logic receives a request to perform a memory access operation from a requestor, such as host system 120. The memory access operation can be directed to one of the plurality of segments of data on a memory device, such as memory device 130. In one embodiment, memory sub-system controller 115 receives the request to perform the memory access operation, such as a program operation, or a read operation, from a requestor, such as host system 120.

At operation 310, the processing logic determines whether an access counter, such as one of access counters 116, corresponding to the segment of data is currently allocated in local memory 119. In one embodiment, if access counter cache 113 identifies a memory access operation directed to a particular segment (e.g., page), it can determine whether a counter corresponding to that segment is currently present in local memory 119. For example, each of the counters 116 can be associated with a certain segment, identified by a memory address or range of memory addresses. In one embodiment, access counter cache 113 can scan the identifies of currently allocated counters to determine if a counter corresponding to the segment associated with the received request is present.

If the processing logic determines that the access counter corresponding to the segment of data identified in the request is currently allocated, at operation 325, the processing logic increments the allocated access counter. In one embodiment, access counter cache 113 increments the corresponding counter by a default amount (e.g., by 1).

If the processing logic determines that the access counter corresponding to the segment of data is not currently allocated, at operation 315, the processing logic determines whether there is adequate capacity to allocate the one of the plurality of access counters. In one embodiment, local memory 119 can have a fixed amount of space designated for access counters. Given that each counter has a certain size, there can be a maximum number of counters 116 allocated in local memory 119 at any one point in time. Accordingly, in one embodiment, access counter cache 113 can determine the number of counters currently allocated and compare that number to the maximum number of counters. If the number of counters currently allocated is less than the maximum number of counters, access counter cache 113 can determine that there is adequate capacity to allocate a new counter. If the number of counters currently allocated is equal to the maximum number of counters, access counter cache 113 can determine that there is not adequate capacity to allocate a new counter.

If the processing logic determines that there is adequate capacity to allocate a new access counter, at operation 320, the processing logic allocates the new counter and, at operation 325, increments the new counter.

If the processing logic determines that there is not adequate capacity to allocate a new counter, at operation 330, the processing logic records an overflow status corresponding to the segment of data on the memory device. In one embodiment, a content addressable memory (CAM) is used to handle overflow if any row of the cache metadata is all valid or to track single status bit overflow in any row.

FIG. 4 is a flow diagram of an example method of providing a host system with hints pertaining to segments of a memory device in a memory sub-system in accordance with some embodiments of the present disclosure. The method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 400 is performed by memory sub-system controller 115, including access counter scanner 114 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 405, the processing logic periodically scans the plurality of access counters to determine whether the plurality of access counters comprise non-zero values. For example, access counter scanner 114 can make a pass over the counters every 10 microseconds. Upon reading the value of each counter, access counter scanner 114 can adjust values prior to a subsequent pass. In one embodiment, access counter scanner 114 adds the current value to the accumulator value and resets the current value to zero. The manner in which the current value and accumulator value are shifted is configurable depending on the specific implementation.

At operation 410, the processing logic determines whether one of the counters 116 includes a non-zero value. If the counter had been previously incremented (e.g., in response to a memory access operation being performed on the corresponding segment of memory device 130), the counter can have a non-zero value (i.e., before it was reset). In one embodiment, access counter scanner 114 reads both the current value and accumulator value and determines if either or both include a non-zero value.

If the processing logic determines that counter comprises a zero value (i.e., the counter does not have a non-zero value), at operation 415, the processing logic can optionally deallocate the counter. In one embodiment, access counter scanner 114 can remove the counter from local memory 119 to make space available for a counter corresponding to a different segment of data. In one embodiment, if the counter has not had a zero value for a certain number of cycles, then the processing logic may not deallocate the counter until it has had a zero value for longer, for example.

If the processing logic determines that counter comprises a non-zero value (i.e., that at least one of the current value and the accumulator value are non-zero), at operation 420, the processing logic adds an indication of a segment of data on the memory device corresponding to the counter to a candidate list.

At operation 425, the processing logic sorts the segments having respective indications in the candidate list based on values of the corresponding access counters. In one embodiment, upon reading the value of each counter 116, access counter scanner 114 can reorder the segments, or at least a portion of the segments corresponding to the counters in view of the respective values. In one embodiment, access counter scanner 114 can sort the segments from a segment with a corresponding access counter having a highest value to a segment with a corresponding access counter having a lowest value.

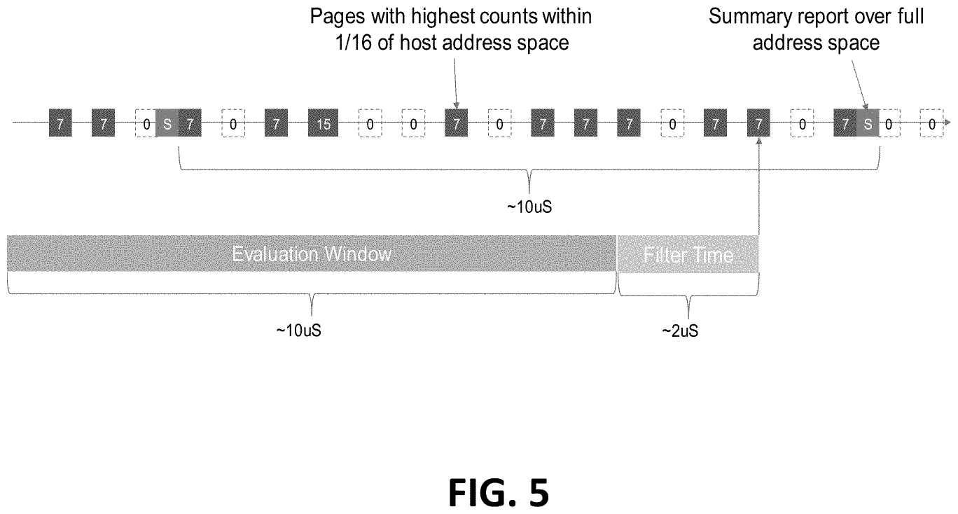

At operation 430, the processing logic determines whether a given candidate (i.e., segment indicated in the candidate list) satisfies a threshold criterion. In one embodiment, in order to maximize the efficiency of page tracking hints sent to host system 120, access counter scanner 114 performs a filtering process to ensure a valid page access entry in all available entries of the access record block. Thus, instead of filtering each segment out based on a threshold, access counter scanner 114 can sort the pages based on access count. For example, access counter scanner 114 can include an indication of either 0, 7, or 15 segments with the highest corresponding counts in the access record block based on a threshold after sorting. In one embodiment, access counter scanner 114 identifies a certain number (e.g., 0, 7, or 15) of segments for which the count values satisfy a threshold criterion within a certain portion of the host address space. For example, as illustrated in FIG. 5, access counter scanner 114 can divide host address space into 16 portions and identify the most frequency accessed segments in each portion. If a certain candidate does not satisfy the threshold criterion, the processing logic can move on to the next candidate in the candidate list and repeat operation 430.

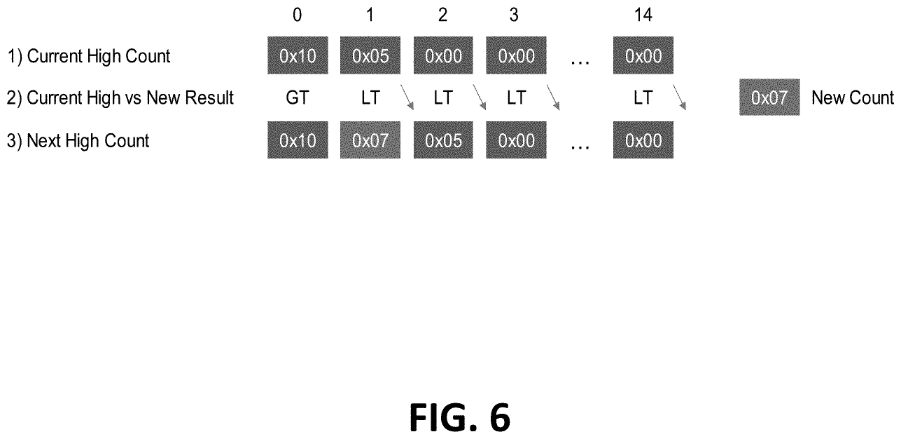

If the candidate does satisfy the threshold criterion, at operation 435, the processing logic adds an entry associated with the candidate to an access record block. In one embodiment, access counter scanner 114 can generate an access record block for any portion of the host address space for which a certain number of segments satisfy the threshold criterion. An access record summary can cover all 16 portions of the host address space. In other embodiments, there can be some other number of portions of the host address space, such as a number of portions equal to any power of two. The example below assumes 16 portions, but it should be understood that in other embodiments, where some other number of portions is used, the values described below can vary. In one embodiment, access counter scanner 114 can identify up to 15 segments, for example, having the highest access counts from a subset of the cache. To do so, access counter scanner 114 can compare the current access count of a given segment in parallel to the values in 15 high count registers, as illustrated in FIG. 6. Access counter scanner 114 can shift all counts that are less than current count and insert the current count into the first register where the previous value was less than the current count. In one embodiment, the page address associated with the high counts are processed in same way in separate set of registers. Assuming 1 clock per compare and shift at 1 GHz, the time to process 1/64 of the cache (4096*20)/64*lns=1280 ns. With four instances operating in parallel, access counter scanner 114 can process 1/16 of the cache in 1280 ns with a lns delay between each row. The four results from each 1/64 section are further sorted through one instance, resulting in a total processing time for 1/16 (256 rows) of cache 1280+15*3=1325 ns and a total number of filtering unit instances required=(1325/256)*4˜24. After the filtering process for 1/16 of cache is complete, access counter scanner 114 can compare high count 0 and 7 with a threshold. Access counter scanner 114 can skip sending an access record block if both counts below threshold.

At operation 440, the processing logic sends the access record block to a host system, such as host system 120. If count 0 only is above the threshold, access counter scanner 114 can send a single ARB of 64B (7 entries) to host system 120. If count 0 and 7 are above the threshold, access counter scanner 114 can send a single access record block of 128B (15 entries) to host system 120. Depending on the embodiment, host system 120 can potentially relocate the one or more segments from memory device 130 (i.e., a non-volatile memory device having a first access time) to a another memory device (e.g., a volatile DRAM device or a non-volatile memory device having a second access time) associated with the host system 120. In one embodiment, the second access time of the memory device associated with the host system is lower than the first access time of memory device 130. Thus, by moving data to the memory device with the lower access time, the host system can access that data faster in response to future requests.

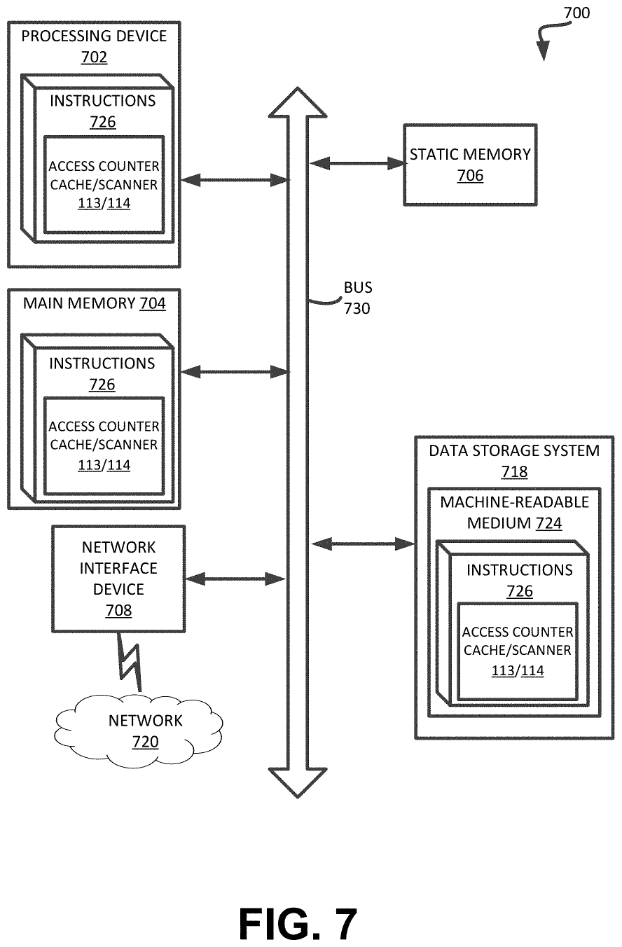

FIG. 7 illustrates an example machine of a computer system 700 within which a set of instructions, for causing the machine to perform any one or more of the methodologies discussed herein, can be executed. In some embodiments, the computer system 700 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to access counter cache 113 and access counter scanner 114 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 700 includes a processing device 702, a main memory 704 (e.g., read-only memory (ROM), flash memory, dynamic random access memory (DRAM) such as synchronous DRAM (SDRAM) or Rambus DRAM (RDRAM), etc.), a static memory 706 (e.g., flash memory, static random access memory (SRAM), etc.), and a data storage system 718, which communicate with each other via a bus 730.

Processing device 702 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 702 can also be one or more special-purpose processing devices such as an application specific integrated circuit (ASIC), a field programmable gate array (FPGA), a digital signal processor (DSP), network processor, or the like. The processing device 702 is configured to execute instructions 726 for performing the operations and steps discussed herein. The computer system 700 can further include a network interface device 708 to communicate over the network 720.

The data storage system 718 can include a machine-readable storage medium 724 (also known as a computer-readable medium) on which is stored one or more sets of instructions 726 or software embodying any one or more of the methodologies or functions described herein. The instructions 726 can also reside, completely or at least partially, within the main memory 704 and/or within the processing device 702 during execution thereof by the computer system 700, the main memory 704 and the processing device 702 also constituting machine-readable storage media. The machine-readable storage medium 724, data storage system 718, and/or main memory 704 can correspond to the memory sub-system 110 of FIG. 1.

In one embodiment, the instructions 726 include instructions to implement functionality corresponding to access counter cache 113 and access counter scanner 114 of FIG. 1). While the machine-readable storage medium 724 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system comprising:
a memory device; and
a processing device, operatively coupled with the memory device, to perform operations comprising:
tracking a plurality of memory access operations directed to a plurality of segments of data on the memory device and maintaining a plurality of access counters corresponding to the plurality of segments;
sorting the plurality of segments based on values of the corresponding access counters;
filtering the plurality of segments to identify a subset of the plurality of segments for which the values of the corresponding access counters satisfy a threshold criterion;
generating a notification comprising an indication of the subset of the plurality of segments; and
providing the notification to a host system after the expiration of a periodic interval.

2. The system of claim 1, wherein the processing device is to perform operations further comprising:
receiving a request to perform one of the plurality of memory access operations from the host system, the one of the plurality of memory access operations directed to one of the plurality of segments of data on the memory device; and
determining whether one of the plurality of access counters corresponding to the one of the plurality of segments of data is currently allocated.

3. The system of claim 2, wherein the processing device is to perform operations further comprising:
responsive to the one of the plurality of access counters corresponding to the one of the plurality of segments of data being currently allocated, incrementing the one of the plurality of access counters.

4. The system of claim 2, wherein the processing device is to perform operations further comprising:
responsive to the one of the plurality of access counters corresponding to the one of the plurality of segments of data not being currently allocated, determining whether there is adequate capacity to allocate the one of the plurality of access counters.

5. The system of claim 4, wherein the processing device is to perform operations further comprising:
responsive to there being adequate capacity to allocate the one of the plurality of access counters, allocating the one of the plurality of access counters and incrementing the one of the plurality of access counters.

6. The system of claim 4, wherein the processing device is to perform operations further comprising:
responsive to there not being adequate capacity to allocate the one of the plurality of access counters, recording an overflow status corresponding to the one of the plurality of segments of data on the memory device.

7. The system of claim 1, wherein the processing device is to perform operations further comprising:
periodically scanning the plurality of access counters to determine whether the plurality of access counters comprise non-zero values.

8. The system of claim 7, wherein the processing device is to perform operations further comprising:
responsive to determining that one of the plurality of access counters comprises a zero value, deallocating the one of the plurality of access counters.

9. The system of claim 7, wherein the processing device is to perform operations further comprising:
responsive to determining that one of the plurality of access counters comprises a non-zero value, adding an indication of one of the plurality of segments of data on the memory device corresponding to the one of the plurality of access counters to a candidate list.

10. The system of claim 9, wherein sorting the plurality of segments based on values of the corresponding access counters comprises sorting the plurality of segments having respective indications in the candidate list from a segment with a corresponding access counter having a highest value to a segment with a corresponding access counter having a lowest value.

11. The system of claim 9, wherein the subset of the plurality of segments for which the values of the corresponding access counters satisfy the threshold criterion comprises segments having respective indications in the candidate list and corresponding access counters having values that exceed a threshold value.

12. A method comprising:
tracking a plurality of memory access operations directed to a plurality of segments of data on a memory device and maintaining a plurality of access counters corresponding to the plurality of segments;
sorting the plurality of segments based on values of the corresponding access counters;
filtering the plurality of segments to identify a subset of the plurality of segments for which the values of the corresponding access counters satisfy a threshold criterion;
generating a notification comprising an indication of the subset of the plurality of segments; and
providing the notification to a host system after the expiration of a periodic interval.

13. The method of claim 12, further comprising:
receiving a request to perform one of the plurality of memory access operations from the host system, the one of the plurality of memory access operations directed to one of the plurality of segments of data on the memory device; and
determining whether one of the plurality of access counters corresponding to the one of the plurality of segments of data is currently allocated.

14. The method of claim 13, further comprising:
responsive to the one of the plurality of access counters corresponding to the one of the plurality of segments of data being currently allocated, incrementing the one of the plurality of access counters.

15. The method of claim 13, further comprising:
responsive to the one of the plurality of access counters corresponding to the one of the plurality of segments of data not being currently allocated, determining whether there is adequate capacity to allocate the one of the plurality of access counters; and
responsive to there being adequate capacity to allocate the one of the plurality of access counters, allocating the one of the plurality of access counters and incrementing the one of the plurality of access counters.

16. The method of claim 15, further comprising:
responsive to there not being adequate capacity to allocate the one of the plurality of access counters, recording an overflow status corresponding to the one of the plurality of segments of data on the memory device.

17. The method of claim 12, further comprising:
periodically scanning the plurality of access counters to determine whether the plurality of access counters comprise non-zero values; and
responsive to determining that one of the plurality of access counters comprises a non-zero value, adding an indication of one of the plurality of segments of data on the memory device corresponding to the one of the plurality of access counters to a candidate list.

18. The method of claim 17, wherein sorting the plurality of segments based on values of the corresponding access counters comprises sorting the plurality of segments having respective indications in the candidate list from a segment with a corresponding access counter having a highest value to a segment with a corresponding access counter having a lowest value.

19. The method of claim 17, wherein the subset of the plurality of segments for which the values of the corresponding access counters satisfy the threshold criterion comprises segments having respective indications in the candidate list and corresponding access counters having values that exceed a threshold value.

20. A non-transitory computer readable storage medium storing instructions which, when executed by a processing device, cause the processing device to perform operations comprising:
generating a plurality of access record blocks, wherein each of the plurality of access record blocks comprises indications of one or more segments in a respective portion of a memory device having a first access time for which a corresponding access count satisfies a threshold criterion; and
providing the plurality of access record blocks to a host system, wherein the host system is to relocate the one or more segments in the respective portion of the memory device having the first access time to a memory device having a second access time associated with the host system, wherein the second access time is lower than the first access time.
